(19) United States
(12) Patent Application Publication
(10) Pub. No.: US 2004/0008213 A1
(43) Pub. Date: Jan. 15, 2004

(54) Tagging multicolor images for improved compression

(75) Inventors: Thomas G. O'Neill, Mountain View, CA (US); Jordan M. Slott, Sunnyvale, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/194,123

(22) Filed: Jul. 11, 2002

(51) Int. Cl. G09G 5/00

(52) U.S. Cl. 345/670

(57) ABSTRACT

The storing of not only image content but information regarding what commands were used to create the image allows for well-informed decision making. The drawing commands are recorded and may be stored in a data structure. This data structure may then be accessed at the time of compression, and the selection of which compression technique to use may be based on the drawing commands. Thus, certain codecs may be applied to certain portions of the image, resulting in a more efficiently compressed image. Pixmaps are data structures holding pixel values corresponding to an image in memory. The data structure utilized here may be a separate RGB pixmap region associated with a pixmap holding image data. This permits the well-informed decision making to be accomplished even when pixmaps are copied to realized (onscreen) windows or other pixmaps.

### FIELD OF THE INVENTION

The present invention relates to the field of computer graphics. More particularly, the present invention relates to the tagging of multicolor images in order to improve compression.

### BACKGROUND OF THE INVENTION

Remote computing applications where screen information is generated on one computer (a “host”) and transmitted for display on another computer (“a display”) are growing in popularity. Examples of some display computers include multipurpose PCs, X-terminals, thin-clients, and Personal Digital Assistants (PDAs).

The X Windows System is a standard that utilizes X client software and X server software to enable the updating of displays at the requests of X client applications. The X server software runs on the host computer. An X client application, which may be running on a different computer, communicates with the X server software by utilizing a low-level library of routines known as Xlib. Xlib provides the functions required to connect to display servers, create windows, render graphics, respond to events, etc. The X server software then may interface with display drivers to actually render the graphics on the display.

X is frequently used as a “local display application”, where the X-server and display are both on the same computer. That is, the same computer is both the “host” and “display” computer. Examples of this usage include running an X-server on a workstation or on an X-terminal. An X-terminal has a computer processor, graphics subsystem and display, but no hard drive. Applications running on other computers use the Xlib routines to communicate with the X-server software running on the X-terminal.

While in some contexts it is advantageous to have the X server and the display on the same computer, this is not necessarily the case in other contexts. One specific context that will be discussed is a remote display application. In such a design, client applications make requests of a centralized server or servers (here known collectively as the “host computer”). The host computer then manages one or more “display computers”, which are typically simple terminal devices.

The SunRay™ product from Sun Microsystems of Palo Alto, Calif. is an example of a thin client which serves as a “display computer” in a remote computing application. A SunRay™ has a processor, graphics subsystem and display, but no hard drive. A SunRay™ is a “display” computer and runs its own proprietary software. The SunRay™ server computer is the “host” and runs the X-server software. The full screen image is maintained both in RAM on the host computer as well as in the frame buffer of the SunRay™ device's video card. In order to synchronize the displays, the host computer sends screen update information to the SunRay™ device via a network protocol known as NewT. The SunRay™ device uses the protocol commands to update the state of its hardware frame buffer.

In remote display applications, an increased burden is placed on the network as more information is transmitted from the host computer to the display computers. It is desirable to reduce network bandwidth used by remote computing applications. Doing so provides shorter transmission times between the host and display computers, reduced load on the network (and resulting improvement in network performance), and the capability to utilize more devices on a single network.

For many typical computing functions such as web browsing, the network bandwidth between the host computer and the display computer is dominated by the transmission of images with a large number of colors, such as photographs or computer generated images which include anti-aliased text or graphics. Unfortunately, these RGB images are frequently sub-images within larger image regions. Thus what is needed is a method for identifying the RGB sub-images and singling them out for special compression—for example using an RGB codec.

The obvious method for doing so would be to inspect pixel values to isolate regions with many colors in the midst of regions with few colors. Unfortunately, this method is CPU-intensive and also is not guaranteed to find the true edges of the RGB image, especially in cases where an RGB image (a) contains pixels that are the same color as the window background, (b) is next to or near other RGB images, or (c) is non-rectangular.

The desired solution would minimize CPU consumption, and furthermore identify the true edges of the RGB image. RGB codecs use the spatial coherency of the image to improve compression. Thus compression would be optimized by inclusion of the full extent of a single image, but no unrelated image data. There are additional penalties if the exact borders of the RGB image are not determined. If the size of an RGB sub-image is underestimated, an additional compression penalty results because the rest of the RGB sub-image is compressed using a mode not suited for use on RGB images. If the size is overestimated, CPU resources are wasted by application of a computer-intensive RGB codec on non-RGB image data. Furthermore, non-RGB data are more likely to exhibit visible artifacts from a lossy RGB codec than are RGB data.

### BRIEF DESCRIPTION OF THE INVENTION

The storing of not only image content but information regarding what commands were used to create the image allows for well-informed decision making. The drawing commands are recorded and may be stored in a data structure. This data structure may then be accessed at the time of compression, and the selection of which compression technique to use may be based on the drawing commands. Thus, certain codecs may be applied to certain portions of the image, resulting in a more efficiently compressed image. Pixmaps are data structures holding pixel values corresponding to an image in memory. The data structure utilized here may be a separate RGB pixmap region associated with a pixmap holding image data. This permits the well-informed decision making to be accomplished even when pixmaps are copied to realized (on-screen) windows or other pixmaps.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating a remote display application such as a SunRay™ network.

FIG. 2 is a block diagram illustrating a remote display application in accordance with a specific embodiment of the present invention.

FIG. 3 is a diagram illustrating an example execution of a specific embodiment of the present invention.

FIG. 4A-4B are flow diagrams illustrating a method for reducing the size of a graphics image in a computer system in accordance with a specific embodiment of the present invention.

FIG. 5 is a flow diagram illustrating a method for compressing a rectangle in accordance with a specific embodiment of the present invention.

FIG. 6 is a flow diagram illustrating a method for reducing the size of a composite graphics image in a computer system in accordance with a specific embodiment of the present invention.

FIG. 7 is a flow diagram illustrating a method for reducing the size of a graphics image in a computer system in accordance with a specific embodiment of the present invention.

FIG. 8 is a block diagram illustrating an apparatus for reducing the size of a composite graphics image in a computer system in accordance with a specific embodiment of the present invention.

FIG. 9 is a block diagram illustrating an apparatus for reducing the size of a graphics image in a computer system in accordance with a specific embodiment of the present invention.

FIG. 10 is a block diagram illustrating an apparatus for reducing the size of a graphics image in a computer system in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a mechanism to identify images with many colors for special treatment. As will be seen, this results in the ability to dramatically reduce network bandwidth while still maintaining image quality.

In remote display applications based on an X server, the Device Dependent X (DDX) layer of the X server may be modified to include possible compression of the screen data and transmission of remote display protocol commands to the display computer. The DDX provides a software interface to a conceptual hardware device. In a specific embodiment of the present invention, the desired results can be accomplished by modifying the DDX, without changing the DIX.

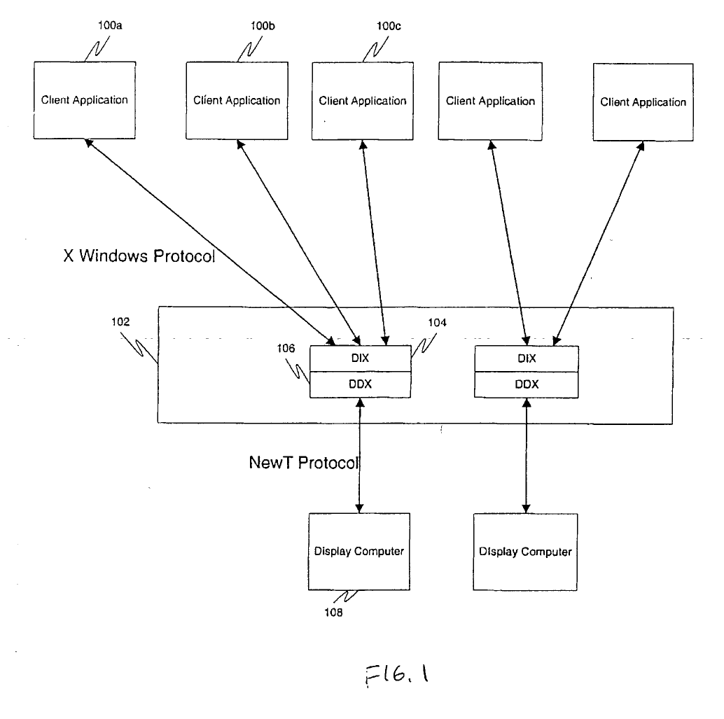

FIG. 1 is a block diagram illustrating a remote display application such as a SunRay™ network. Client applications 100a-100c send information to and receive information from the host computer 102 over the X Windows Protocol. Some of the information is many-colored image information. The host computer utilizes a device independent layer (DIX) 104 to act as a controlling layer, which handles initialization procedures and all device-independent handling of requests and events. A device dependent layer (DDX) 106 then is used to handle device dependent functionality. The DDX 106 then communicates with display computer 108 using the NewT protocol. The DIX and the DDX essentially make up an X-server.

When sending update information for a screen region, there are a few cases where the SunRay™ host takes the individual drawing operations into account when deciding how to compress the data. For example, if an opaque, single-color fill command is performed to a realized (on-screen) window, then the host software immediately sends the appropriate 1-color rectangle commands to the SunRay™ device without actually having to inspect the pixel values. Another example is the compression of fills with tiled backgrounds, which repeat every N pixels in the vertical and M pixels in the horizontal direction. In that case, the SunRay™ host computer sends one copy of the tile and then requests local copies on the display computer to fill the rest of the tiled background. However, this type of well-informed compression decision making is only performed when the drawing is made directly to a realized window.

But in most cases the drawing history is not used and the compression decisions are made based on after-the-fact inspection of the individual pixel vales. The SunRay™ host typically scans the pixel values in the region to identify contiguous sequences of one, two, or many colors. The contiguous sequences are then sent in separate NewT protocol commands. For example, the two color regions may be sent using a bitmap encoding, where one bit for each pixel specifies which of the two colors is present. By contrast, many-colored regions are sent with minimal compression (24-bit RGB values instead of the full 32-bit XRGB).

An important case where pixel inspection is used is when an off-screen pixmap is copied onto a realized window. A pixmap is an array of pixel values in memory which can be used to store an image off-screen. Each pixel is represented by a certain number of bits depending upon the number of possible colors in the image. On the one hand, a single bit-per-pixel bitmap is used to represent up to two color images. On the other hand, a 24 bits-per-pixel bitmap is used for images with many colors. In X Windows, pixmaps are often used, but not exclusively, as off-screen staging areas where complex images are formed using several independent drawing commands. Unfortunately, when an off-screen pixmap is copied to a realized window (using the XCopyArea command), the SunRay™ device performs compression without using any information about the individual drawing operations used to create the composite image in the pixmap. This explains at least partially why pixmap copies frequently dominate the bandwidth between the host and display computers in SunRay™ systems.

The present invention, on the other hand, allows for well-informed decision making even when pixmaps are copied to realized windows. In the present invention, this is accomplished by maintaining and using information about how the pixmap image was created to achieve better decision making about how best to compress the image data. Additionally, it should be pointed out that for purposes of this application, the term pixmap should be construed to cover traditional pixmaps as well as any other type of image staging area that isn't part of the final image being created. In fact, the invention may be used any time it is useful to compress a set of image data that has been created with a sequence of drawing commands, and information is available about what commands were used for different portions of the image.

One example use for the present invention would be to improve compression of images created in pixel-based (as opposed to vector-based) drawing programs. Here, one might keep track of the drawing commands (circle, filled circle, square, image importation, etc.) used to draw the different portion of the image and use that information to influence compression decisions when saving the results to a file.

In the present application, an embodiment of the present invention is described in the context of a modification of traditional X Windows technology for use with remote computing applications. However, one of ordinary skill in the art will recognize that other embodiments are possible and the present invention should not be limited to X Windows, SunRay™, or remote computing technology.

For purposes of this application, an RGB image may be defined as one that is rendered from a list of pixel values (in contrast to an image rendered from a specification of a geometric figure or text characters to draw). In a drawing program, such an image may be an imported JPEG image where the pixel values are computed from the compressed JPEG data. In an X Server, this may be an image drawn with the XPutImage command, where the pixel values are provided directly by the client application. XPutImage copies the image data in an XImage structure into an area of a window or a pixmap. This is the typical way to create many-colored images on an X server, as the other drawing primitives are typically used to draw only one or two colors at a time.

While XPutImage is a specific command in the X Windows System, the term put image command may be used in the present application to refer to any rendering command used to create an RGB image.

When RGB image regions are present in the image to be compressed, they can easily dominate the size of the compressed image. Thus, the present application focuses on the compression of RGB images. Nevertheless, the techniques described can be extended to other types of images that were drawn using different graphics primitives.

In a specific embodiment of the present invention, the region of the pixmap which was rendered using a put image command may be tracked. When the pixmap is copied onto a realized window, this “RGB region” may be sent to the display computer separately from the non-RGB region. The RGB region may be compressed using an RGB codec before sending.

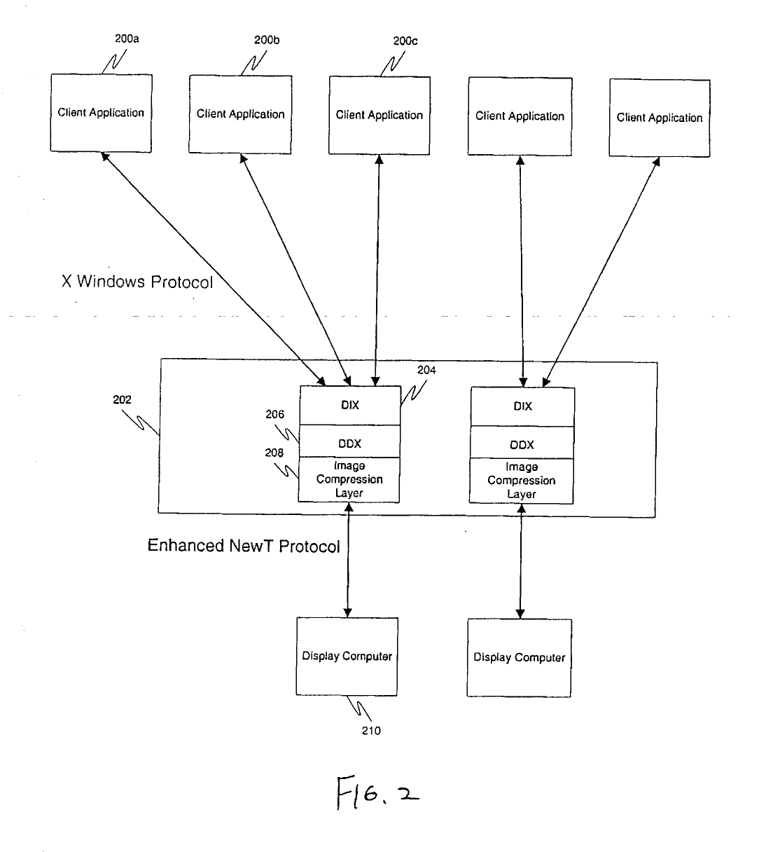

FIG. 2 is a block diagram illustrating a remote display application in accordance with a specific embodiment of the present invention. Client applications 200a-200c send information to and receive information from the host computer 202 over the X Windows Protocol. Some of the information is many-colored image information. The host computer utilizes a device independent layer (DIX) 204 to act as a controlling layer, which handles initialization procedures and all device-independent handling of requests and events. A device dependent layer (DDX) 206 then is used to handle device dependent functionality. An image compression layer 208 may then be provided which performs the additional image compression techniques discussed in the present application. Alternatively, this image compression layer may simply be part of a modified DDX. The image compression layer 208 then communicates with display computer 210 using an enhanced version of the NewT protocol.

Improved compression may be achieved by using an image-compression scheme specifically designed for use on RGB images. Such schemes may be known as “RGB codecs”. The choice of codec will depend on the requirements of the application. A developer may make trade-offs between image quality, network bandwidth, and encoder and decoder CPU utilization in deciding which codec to utilize. A developer may choose a lossless compression technique, which is one that decompresses data back to its original form without any loss in quality (the decompressed image and the original are identical), such as LZ compression. Doing so, however, normally results in only a modest improvement in network performance. Alternatively, a developer may choose a lossy compression technique, which is one that does not decompress the image data exactly back to its original form, such as JPEG. This results in better compression and better network performance, but the resulting graphics are imperfect. There is a wide variety, however, of possible lossy techniques to use, each with a different degree of compression and loss, such that a developer may choose a happy medium, where image quality is imperfect but indistinguishable from the original for the majority of users.

In one embodiment of the present invention, the RGB portion of the pixmap may be described by a single X region resource called the “RGB region”. The region resource may be associated with the pixmap through the use of the DDX pixmap devPrivates facility, which allows an X extension to attach a private data structure to each X pixmap. In X, a region resource may be used to describe an arbitrarily shaped piece of real estate in XY pixel space. I.e., it can be used to describe an arbitrary collection of pixels by characterizing their XY positions. In X, the positions are characterized by an array of rectangles for which every pixel is in the region. This representation is efficient for regularly-shaped regions, which occur frequently in X, but inefficient for regions with a lot of isolated pixels, which occur much less frequently in X. The rectangle representation is also very convenient for remote display applications such as SunRay™, where each protocol command specifies the screen update for a single screen rectangle.

X also provides a series of routines for performing set operations (union, subtraction, intersection, etc.) on the region resources, which are very convenient in the practice of the invention. The region resources and routines were originally developed to assist with the computation of clipping and drawn-to regions. The composite clip list for a drawable (window or pixmap) represents the region that can currently be drawn to. It includes the effects of clipping requested by the client application (the client clip list) and, if the drawable is a window, by other windows that are on top of the window in question. The drawn-to region for a particular DDX command is found by intersecting the composite clip list with the region that the command would render in the absence of clipping. It is this region to which the command actually renders.

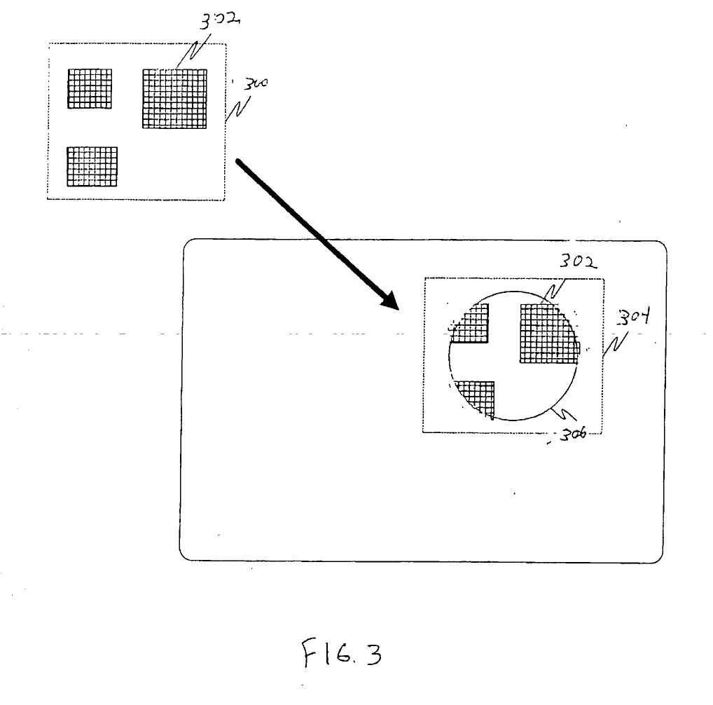

FIG. 3 is a diagram illustrating an example execution of a specific embodiment of the present invention. In this example, the pixmap 300 is rendered with an opaque, single-color PolyFillRect command, followed by three PutImage commands. The shaded rectangles 302 indicate the drawn-to regions for each of these PutImage commands. Note that if the X client application specified a client clip list, then the drawn-to regions would not necessarily be rectangular. As each PutImage command is executed, the corresponding drawn-to region is added to the RGB region for the pixmap. Finally, a CopyArea command is used to copy the pixmap onto the realized window 304. In the example shown, a circular client clip list is used for the CopyArea, resulting in a circular drawn-to region 306. The intersection of the pixmap's RGB region (properly translated) with the drawn-to region of the CopyArea command yields the RGB portion of the drawn-to region. This portion is represented by the shaded portion of 306. This portion should be compressed with an RGB codec. The remainder of the drawn-to region can be compressed using a compression mode intended for non-RGB data. Once the display computer receives both the RGB and non-RGB update information, it can reassemble the entire composite image 306.

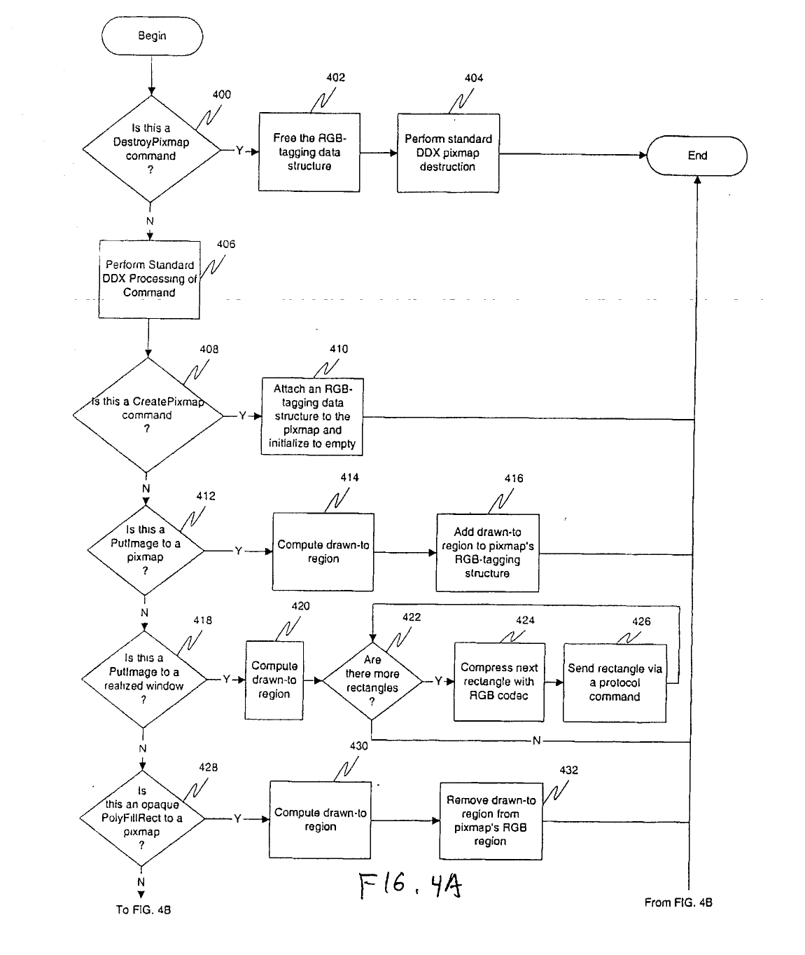

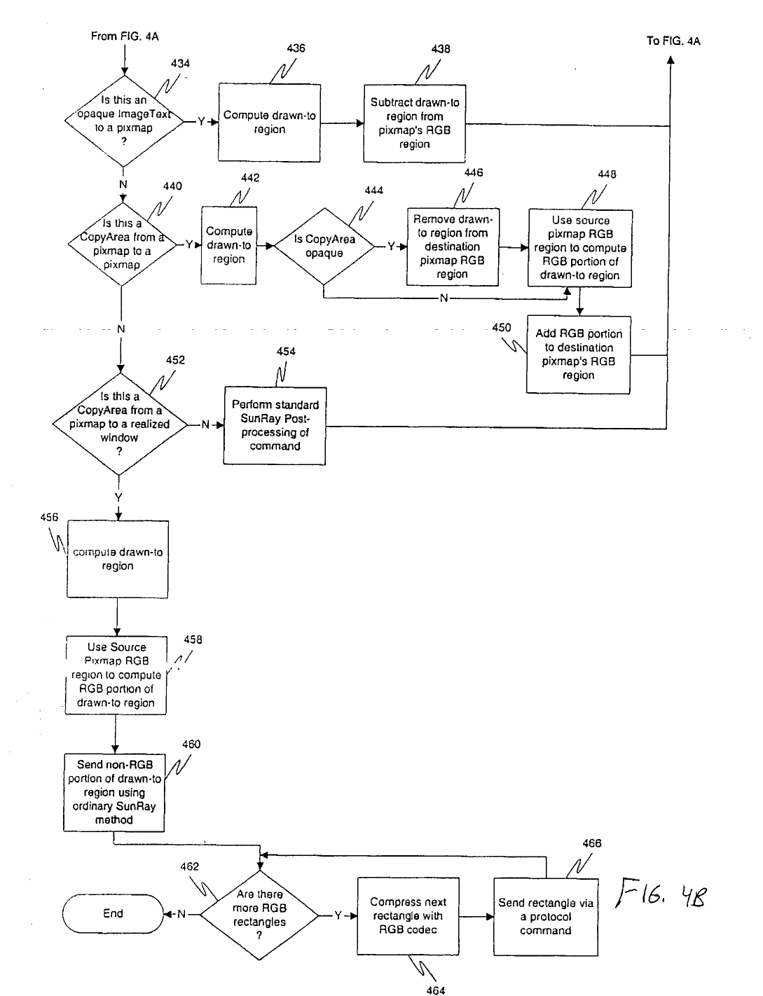

FIGS. 4A-4B are flow diagrams illustrating a method for reducing the size of a graphics image in a computer system in accordance with a specific embodiment of the present invention. These figures show the processing of a single DDX command in accordance with a specific embodiment of the present invention. These figures refer specifically to an embodiment where the SunRay™ server software is modified to practice the invention. One of ordinary skill in the art will recognize that this method may be modified for use with other remote display applications. In this embodiment, several DDX commands may require special handling. These include CreatePixmap, DestroyPixmap, PutImage, PolyFilIRect, ImageText, and CopyArea. Referring first to FIG. 4A, at 400, it is determined if the command is a DestroyPixmap command. It should be noted that one of ordinary skill in the art will recognize that a destroy pixmap command, any command utilized to destroy or remove a pixmap or pixmap-like structure, could be substituted for DestroyPixmap. If it is a DestroyPixmap command, then at 402, the RGB-tagging data structure may be freed and at 404 the standard DDX pixmap destruction may be performed. If it is not a DestroyPixmap command, then at 406 the standard DDX routine for the command is called.

At 408 it is determined if the command is a CreatePixmap command. It should be noted that one of ordinary skill in the art will recognize that a create pixmap command, any command utilized to create a pixmap or pixmap-like structure, could be substituted for CreatePixmap. If the command is a CreatePixmap command, then at 410, an RGB tagging data structure is attached to the pixmap and the RGB region is initialized to empty.

At 412, it is determined if the command is a PutImage to a pixmap. It should be noted that one of ordinary skill in the art will recognize that a put image command, any command utilized to create an RGB image, may be substituted for PutImage. If so, then at 414 the drawn-to region is computed. Then at 416, the drawn-to region is added to the pixmap's RGB region and processing is complete. If the command is not a PutImage to a pixmap, then at 418 it is determined if the command is a PutImage to a realized window. If so, then at 420 the drawn-to region is computed. Then, at 422 it is determined if there are any more rectangles in the drawn-to region. If so, the process moves to 424. Thus, for each rectangle in the drawn-to region, the rectangle is compressed using an RGB codec and, at 426, sent via a protocol command. When the last rectangle is sent, processing is complete.

If the command is not a PutImage to a realized window, then at 428 it is determined if the command is an opaque PolyFillRect to a pixmap. It should be noted that one of ordinary skill in the art will recognize that an opaque poly fill rectangle command, any command utilized to overwrite a rectangle with a single color or a tiled pattern, could be substituted for PolyFillRect. PolyFillRect commands are frequently used to set a region to the background color or pattern. In the case of the X Windows System, a PolyFillRect command is opaque when the graphics context indicates that (a) all color planes are affected; (b) the logical function is GXcopy, GXclear, GXset, or GXcopylnverted; and (c) the fill style is solid, tiled, or opaque stippled (i.e., the style is not stippled). If the command is an opaque PolyFillRect command, then at 430 the drawn-to region is computed. Then at 432, the drawn-to region is removed from the pixmap's RGB region. This special handling of PolyFillRect commands is useful to prevent the waste of CPU resources that would result from applying an RGB codec to a region where an RGB image has been overwritten by a non-RGB image. Note that if the PolyFillRect command is not opaque, then any pre-existing RGB image is not fully overwritten and so the RGB region is not adjusted.

Referring now to FIG. 4B, if the command is not an opaque PolyFillRect to a pixmap, then at 434 it is determined if the command is an opaque ImageText to a pixmap. If so, at 436, the drawn-to region is computed. Then, at 438, the drawn-to region is subtracted from the pixmap s RGB region and processing is complete.

If the command is not an opaque ImageText to a pixmap, then at 440 it is determined if the command is a CopyArea from a pixmap to a pixmap. If so, then at 442, the drawn-to region is computed. Then at 444, it is determined if the CopyArea is opaque. If so, then at 446, the drawn-to region is removed from the RGB region of the destination pixmap. Then at 448, the RGB portion of the drawn-to region is found by translating the RGB region of the source pixmap to the destination coordinates and intersecting with the drawn-to region. The destination coordinates are those coordinates in the destination pixmap to which the CopyArea command copies the source pixmap. Then at 450, the RGB portion of the drawn-to region is added to the RGB region of the destination pixmap. This sequence ensures proper handling when an RGB image in the destination pixmap is overwritten, and when an RGB image in the source pixmap is used to create an RGB image in the destination pixmap.

If the command is not a CopyArea from a pixmap to a pixmap, then at 452 it is determined if the command is a CopyArea from a pixmap to a realized window. If not, then the system may simply perform standard SunRay™ post-processing of the command at 454. For example, if the command renders to a realized window, then the SunRay™ software sends the appropriate screen update information to the display computer.

If the command is a CopyArea from a pixmap to a realized window, then at 456 the drawn-to region is computed. Then at 458, the RGB portion of the drawn-to region may be found by translating the RGB region of the source pixmap to the destination coordinates and intersecting with the drawn-to region. The destination coordinates are those screen coordinates to which the CopyArea command copies the pixmap. At 460, the non-RGB portion of the drawn-to-region is sent to the display computer using the standard SunRay™ method. Then at 462, it is determined if there are more RGB rectangles. Then, for each rectangle in the RGB portion, the rectangle is compressed using an RGB codec at 464 and sent via a protocol command at 466. When the last rectangle is sent, processing is complete.

The rationale for the special handling of drawing primitives such as PolyFillRectangle and ImageText but not for others such as PolyArc and PolyText is that the former routines are typically used to overwrite rectangular areas of the destination drawable's image. Thus taking them into account reduces the size of the RGB region without significantly increasing the number of rectangles in the RGB region. The regions overwritten by the other commands tend to be irregularly-shaped (non-rectangular), so taking them into account would carve the RGB region up into a large number of smaller rectangles which do not compress as well with an RGB codec. Note that if the RGB codec is too lossy, this method can result in visible degradation of such non-RGB images included in the RGB region. Fortunately, it is relatively rare for such non-RGB images to be drawn on top of RGB images. Still, the problem can be avoided by use of lossless or nearly-lossless codecs. In principle, the practitioner can even keep track of two separate RGB regions: a “pure” RGB region which has not been overwritten by PolyArc, etc. and an “impure” RGB region which has. The pure RGB region could then be compressed with a lossy codec and the impure RGB region could be compressed with a lossless or nearly-lossless codec.

Since best compression results when the RGB region is composed of large rectangles, the method described in FIGS. 4A-4B may be refined. In this refinement, addition to and subtraction from the pixmap's RGB region would only occur if the drawn-to region is deemed to be sufficiently large.

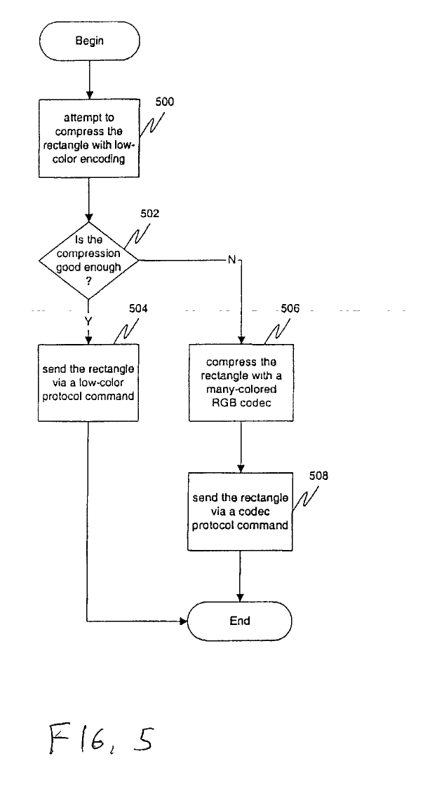

In a specific embodiment of the present invention, 424 of FIG. 4A and 464 of FIG. 4B may be more complicated than merely using a single codec. RGB images tend to fall into one of two broad categories: (1) many-colored pictures which typically compress well with RGB codecs, and (2) low-colored images for which higher compression may result through the use of low-color and/or run-length encoding. FIG. 5 is a flow diagram illustrating a method for compressing a rectangle in accordance with a specific embodiment of the present invention. This method could conceivably replace 424-426 of FIG. 4A and 464-466 of FIG. 4B. At 500, an attempt is made to compress the rectangle with low-color encoding. At 502, it is determined if the compression is good enough. If so, then at 504 the rectangle may be sent via a low-color protocol command. If not, then at 506 the rectangle may be compressed with a many-colored RGB codec. Examples include Differential Pulse Code Modulation (DPCM) and Discrete Cosine Transform (DCT). The choice as to which codec to apply may be based on the available bandwidth: DCT requires more thin client CPU cycles but achieves better compression. Then at 508, the rectangle may be sent via a codec protocol command. One of ordinary skill in the art will recognize that such a technique can easily be generalized to select an appropriate match from any number of image compression schemes.

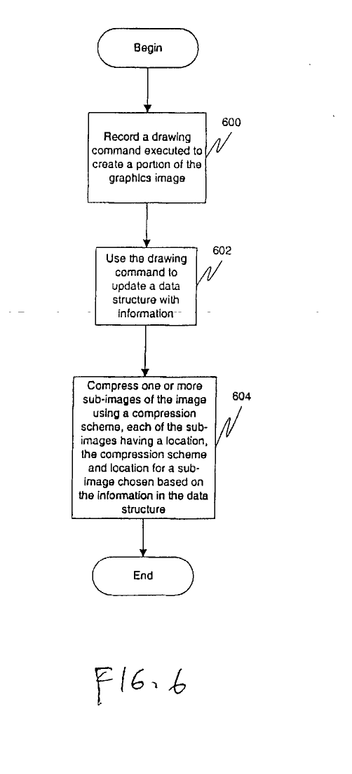

FIG. 6 is a flow diagram illustrating a method for reducing the size of a composite graphics image in a computer system in accordance with a specific embodiment of the present invention. In this embodiment, a certain class of image data (e.g., RGB sub-images) are singled out for special compression, using a compression mode appropriate for the class of image data. A set of one or more drawing commands (e.g. PutImage and CopyArea from a pixmap containing one or more RGB sub-images) may be identified as creating sub-images of this class. Another set of one or more drawing commands (e.g., opaque PolyFillRect) may be identified as overwriting sub-images of this class.

At 600, a drawing command is recorded. Command recording may or may not be limited to commands from the two sets of drawing commands identified above. This drawing command may also be one that is executed during the rendering of said composite graphics image. The graphics image may be created in a pixmap. At 602, the drawing command is used to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible choices for the method of associating the two.

The information in the data structure may enable determination of what portion of the composite image contains sub-images of the specified image class. One example data structure would be a bitmask identifying which pixels were rendered with a specific drawing command. Alternatively, the data structure may be a series of partially-transparent overlap layers which would reconstruct the full pixmap image when combined, where a different layer is kept for each command. In a specific embodiment of the present invention, an X region resource is used to store the region of the pixmap which contains sub-images of the specified image class.

At 604, one or more sub-images from the composite graphics image may be compressed using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. 604 may occur when the XCopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

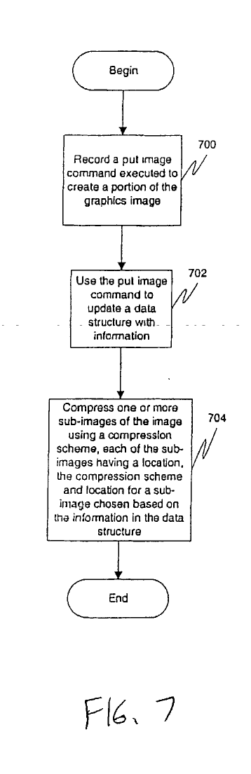

FIG. 7 is a flow diagram illustrating a method for reducing the size of a graphics image in a computer system in accordance with a specific embodiment of the present invention. At 700, a put image command executed to create a portion of the graphics image in a pixmap may be recorded. At 702, the put image command is used to update a data structure with information. This may include using information about the region to which the put image command applies to update the data structure. The data structure may be an X region resource identifying the region that was rendered by one or more put image commands. The data structure may also be a series of partially-transparent overlap layers. It may also be a bitmask identifying which pixels were rendered with the put image command. At 704, one or more sub-images from the composite graphics image may be compressed using a compression scheme, with both the location of the sub-images and the compression scheme based on the information in the data structure.

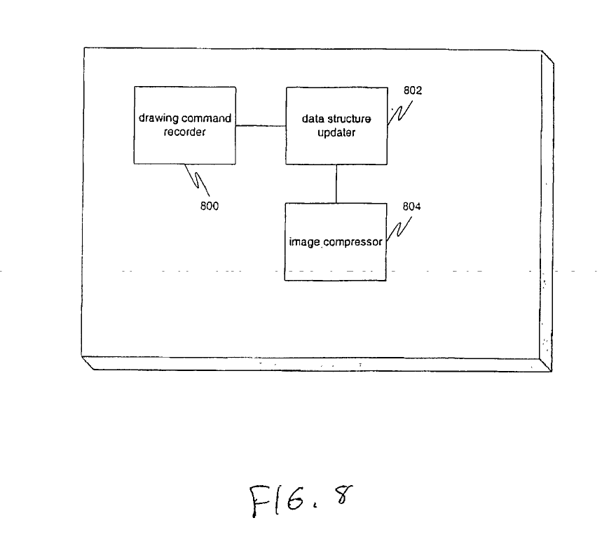

FIG. 8 is a block diagram illustrating an apparatus for reducing the size of a composite graphics image in a computer system in accordance with a specific embodiment of the present invention. In this embodiment, a certain class of image data (e.g., RGB sub-images) are singled out for special compression, using a compression mode appropriate for the class of image data A set of one or more drawing commands (e.g. CopyArea from a pixmap containing one or more RGB sub-images and PutImage) may be identified as creating sub-images of this class. Another set of one or more drawing commands (e.g., opaque PolyFillRect) may be identified as overwriting sub-images of this class.

A drawing command recorder 800 may record a drawing command. Command recording may or may not be limited to commands from the two sets of drawing commands identified above. This drawing command may also be one that is executed during the rendering of said composite graphics image. The graphics image may be created in a pixmap. A data structure updater 802 coupled to the drawing command recorder 800 may use the drawing command to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible methods for associating the two.

The information in the data structure may enable determination of what portion of the composite image contains sub-images of the specified image class. One example data structure would be a bitmask identifying which pixels were rendered with a specific drawing command. Alternatively, the data structure may be a series of partially-transparent overlap layers, where a different layer is kept for each command. In a specific embodiment of the present invention, an X region resource is used to store the region of the pixmap which contains sub-images of the specified image class.

An image compressor 804 coupled to said data structure updater 802 may compress one or more sub-images from the composite graphics image using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. The compression may occur when the XCopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

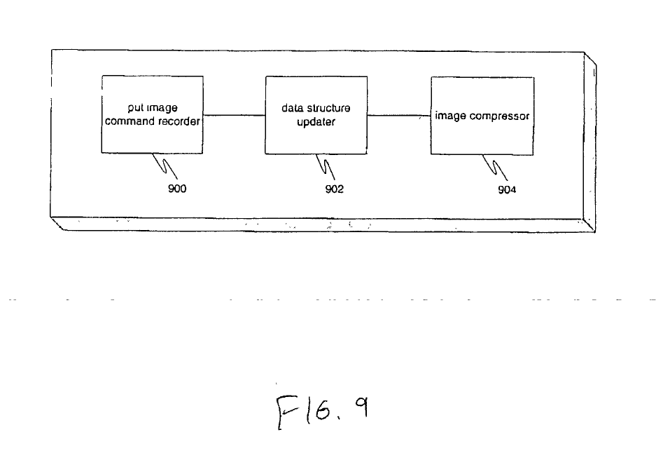

FIG. 9 is a block diagram illustrating an apparatus for reducing the size of a graphics image in a computer system in accordance with a specific embodiment of the present invention. A put image command recorder 900 may record a put image command executed to create a portion of the graphics image in a pixmap. A data structure updater 902 coupled to said put image command recorder 900 may use the put image command to update a data structure with information. This may include using information about the region to which the put image command applies to update the data structure. The data structure may be an X region resource identifying the region that was rendered by the put image command. The data structure may also be a series of partially-transparent overlap layers. It may also be a bitmask identifying which pixels were rendered with the put image command. An image compressor 904 coupled to said data structure updater 902 may compress one or more sub-images from the composite graphics image using a compression scheme, with both the location of the sub-images and the compression scheme based on the information in the data structure.

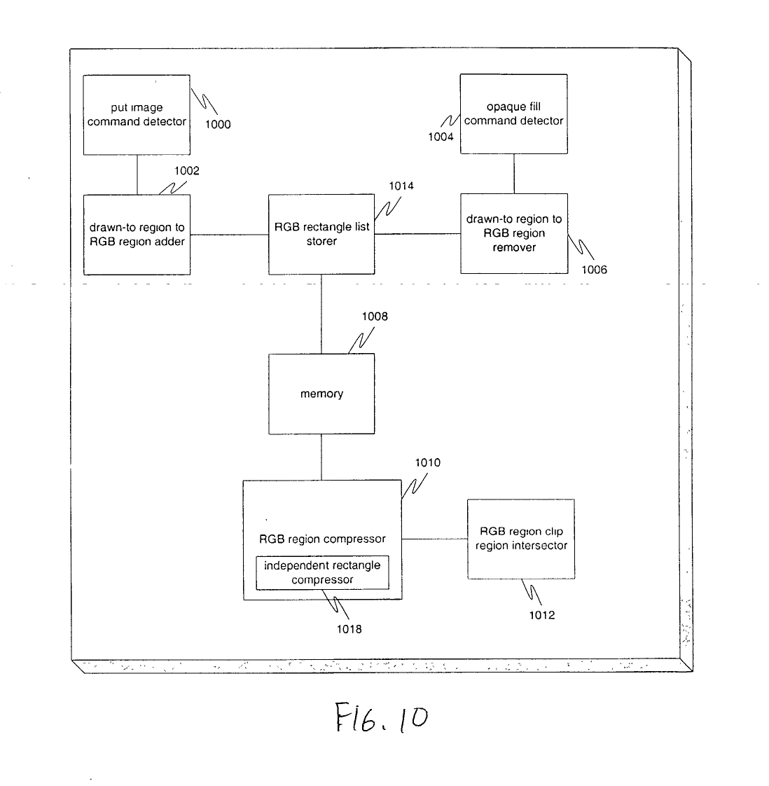

FIG. 10 is a block diagram illustrating an apparatus for reducing the size of a graphics image in a computer system in accordance with a specific embodiment of the present invention. A put image command detector 1000 detects when a put image command is executed. A drawn-to region to RGB region adder 1002 coupled to the put image command detector 1000 adds a drawn-to region to an RGB region when a put image command is executed. An opaque fill command detector 1004 detects when an opaque fill command is executed. A drawn-to region to RGB region remover 1006 coupled to the opaque fill command detector 1004 removes a drawn-to region from the RGB region when an opaque fill command is executed. A memory 1008 coupled to the drawn-to region to RGB region remover 1006 may store the RGB region. An RGB region compressor 1010 coupled to the memory 1008 may then compress the RGB region before transmitting it for display. An RGB region clip region intersector 1012 coupled to the memory 1008 and to the RGB region compressor 1010 may intersect the RGB region with a clip region before compression occurs. For example, the clip region may be the composite clip region, the window clip list (where overlapping windows have been subtracted away), or the client clip list. An RGB region rectangle list storer 1016 coupled to the drawn-to region to RGB region adder 1002, the drawn-to region to RGB region remover 1006, and the memory 1008 may store the RGB region as a series of rectangles. Then an independent rectangle compressor 1018 within the RGB region compressor 1010 may compress each rectangle independently.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for reducing the size of a graphics image in a computer system, comprising:
recording a drawing command executed to create a portion of the graphics image; and
compressing said portion of the graphics image using a compression scheme, said compression scheme selected based on said drawing command.

2. A method for reducing the size of a graphics image in a computer system, comprising:
recording a drawing command executed to create a portion of the graphics image in a pixmap;
using said drawing command to update a data structure associated with said pixmap with information; and
compressing one or more sub-images of the graphics image using a compression scheme, each of said sub-images having a location, said location and said compression scheme for each of said sub-images chosen based on said information in said data structure.

3. The method of claim 2, wherein said data structure is associated with said pixmap using a private data field attached to said pixmap.

4. The method of claim 3, wherein said private data field is a pixmap devPrivates field.

5. The method of claim 2, wherein said data structure associated with said pixmap is a series of partially-transparent overlap layers.

6. The method of claim 2, wherein said data structure associated with said pixmap identifies the portion of the pixmap image that was created with a specific drawing command.

7. The method of claim 6, wherein said data structure associated with said pixmap is a bitmask identifying which pixels were rendered with a specific drawing command.

8. The method of claim 6, wherein said data structure associated with said pixmap is a list of rectangles specifying which pixels were rendered with a specific drawing command.

9. The method of claim 2, wherein said compression scheme is an RGB codec.

10. A method for reducing the size of a graphics image in a computer system, comprising:
recording a put image command executed to create a portion of the graphics image in a pixmap;
using said put image command to update a data structure associated with said pixmap with information; and
compressing one or more sub-images of the graphics image using a compression scheme, each of said sub-images having a location, said location and said compression scheme for each of said sub-images chosen based on said information in said data structure.

11. The method of claim 10, wherein said data structure associated with said pixmap is a series of partially-transparent overlap layers.

12. The method of claim 10, wherein said data structure associated with said pixmap identifies the portion of the pixmap image that was created with a specific drawing command.

13. The method of claim 12, wherein said data structure associated with said pixmap is a bitmask identifying which pixels were rendered with a specific drawing command.

14. The method of claim 12, wherein said data structure associated with said pixmap is a list of rectangles specifying which pixels were rendered with a specific drawing command.

15. The method of claim 10, wherein said compression scheme is an RGB codec.

16. A method for reducing the size of a graphics image in a computer system, comprising:
adding a drawn-to region to an RGB region when a put image command is executed;
removing a drawn-to region from said RGB region when an opaque fill command is executed;
compressing said RGB region using a compression scheme, said compression scheme optimized for use with RGB images.

17. The method of claim 16, further comprising intersecting said RGB region with a clip region before said compressing.

18. The method of claim 16, wherein said drawn-to region represents the region to which a command renders.

19. The method of claim 17, wherein said clip region represents the area in which the image may be drawn.

20. The method of claim 16, further comprising storing said RGB region in an RGB-tagging data structure.

21. The method of claim 20, wherein said storing comprises storing said RGB region as a list of rectangles in an RGB-tagging data structure.

22. The method of claim 21, wherein said compressing comprises:
compressing each of said one or more rectangles independently.

23. An apparatus for reducing the size of a graphics image in a computer system, comprising:
a drawing command recorder;
an image compressor coupled to said drawing command recorder.

24. An apparatus for reducing the size of a graphics image in a computer system, comprising:
a drawing command recorder;
a data structure updater coupled to said drawing command recorder; and
an image compressor coupled to said data structure updater.

25. An apparatus for reducing the size of a graphics image in a computer system, comprising:
a put image command recorder;
a data structure updater coupled to said put image command recorder; and
an image compressor coupled to said data structure updater.

26. An apparatus for reducing the size of a graphics image in a computer system, comprising:
a put image command detector;
a drawn-to region to RGB region adder coupled to said put image command detector;
an opaque fill command detector;
a drawn-to region to RGB region remover coupled to said opaque fill command detector;
a memory coupled to said drawn-to region to RGB region adder and to said drawn-to region to RGB region remover; and
an RGB region compressor coupled to said memory.

27. The apparatus of claim 26, further comprising an RGB region clip region intersector coupled to said memory and to said RGB region compressor.

28. The apparatus of claim 26, further comprising an RGB region rectangle list storer coupled to said drawn-to region to RGB region adder, said drawn-to region to RGB region remover and said memory.

29. The apparatus of claim 28, wherein said RGB region compressor comprises an independent rectangle compressor.

30. An apparatus for reducing the size of a graphics image in a computer system, comprising:
means for recording a drawing command executed to create a portion of the graphics image; and
means for compressing said portion of the graphics image using a compression scheme, said compression scheme selected based on said drawing command.

31. An apparatus for reducing the size of a graphics image in a computer system, comprising:
means for recording a drawing command executed to create a portion of the graphics image in a pixmap;
means for using said drawing command to update a data structure associated with said pixmap with information; and
means for compressing one or more sub-images of the graphics image using a compression scheme, each of said sub-images having a location, said location and said compression scheme for each of said sub-images chosen based on said information in said data structure.

32. The apparatus of claim 31, wherein said data structure associated with said pixmap is a series of partially-transparent overlap layers.

33. The apparatus of claim 31, wherein said compression scheme is an RGB codec.

34. The apparatus of claim 31, wherein said data structure associated with said pixmap identifies the portion of the pixmap image that was created with a specific drawing command.

35. The apparatus of claim 34, wherein said data structure associated with said pixmap is a bitmask identifying which pixels were rendered with a specific drawing command.

36. The method of claim 35, wherein said data structure associated with said pixmap is a list of rectangles specifying which pixels were rendered with a specific drawing command.

37. An apparatus for reducing the size of a graphics image in a computer system, comprising:
means for recording a put image command executed to create a portion of the graphics image in a pixmap;
means for using said put image command to update a data structure associated with said pixmap with information; and
means for compressing one or more sub-images of the graphics image using a compression scheme, each of said sub-images having a location, said location and said compression scheme for each of said sub-images chosen based on said information in said data structure.

38. The apparatus of claim 37, wherein said data structure is associated with said pixmap using a private data field attached to said pixmap.

39. The apparatus of claim 38, wherein said private data field is a pixmap devPrivates field.

40. The apparatus of claim 37, wherein said data structure associated with said pixmap is a series of partially-transparent overlap layers.

41. The apparatus of claim 39, wherein said data structure associated with said pixmap identifies the portion of the pixmap image that was created with a specific drawing command.

42. The apparatus of claim 41, wherein said data structure associated with said pixmap is a bitmask identifying which pixels were rendered with a specific drawing command.

43. The apparatus of claim 41, wherein said data structure associated with said pixmap is a list of rectangles specifying which pixels were rendered with a specific drawing command.

44. The apparatus of claim 37, wherein said compression scheme is an RGB codec.

45. An apparatus for reducing the size of a graphics image in a computer system, comprising:
means for adding a drawn-to region to an RGB region when a put image command is executed;
means for removing a drawn-to region from said RGB region when an opaque fill command is executed; and
means for compressing said RGB region using a compression scheme, said compression scheme optimized for use with RGB regions.

46. The apparatus of claim 45, further comprising means for intersecting said RGB region with a clip region before said compressing.

47. The apparatus of claim 45, wherein said drawn-to region represents the region to which a command renders.

48. The apparatus of claim 46, wherein said clip region represents the area in which the image may be drawn.

49. The apparatus of claim 45, further comprising means for storing said RGB region in an RGB-tagging data stricture.

50. The apparatus of claim 49, wherein said means for storing comprises means for storing said RGB region as a list of rectangles in an RGB-tagging data structure.

51. The apparatus of claim 49, wherein said means for compressing comprises:
means for compressing each of said one or more rectangles independently.

52. A program storage device readable by a machine, tangibly embodying a program of instructions executable by the machine to perform a method for reducing the size of a graphics image in a computer system, the method comprising:
recording a drawing commands executed to create a portion of the graphics image; and
compressing said portion of the graphics image using a compression scheme, said compression scheme selected based on said drawing command.

53. A program storage device readable by a machine, tangibly embodying a program of instructions executable by the machine to perform a method for reducing the size of a graphics image in a computer system, the method comprising: recording a drawing command executed to create a portion of the graphics image in a pixmap;
using said drawing command to update a data structure associated with said pixmap with information; and
compressing one or more sub-images of the graphics image using a compression scheme, each of said sub-images having a location, said location and said compression scheme for each of said sub-images chosen based on said information in said data structure.

54. A program storage device readable by a machine, tangibly embodying a program of instructions executable by the machine to perform a method for reducing the size of a graphics image in a computer system, the method comprising:
recording a put image command executed to create a portion of the graphics image in a pixmap;
using said put image command to update a data structure associated with said pixmap with information; and
compressing one or more sub-images of the graphics image using a compression scheme, each of said sub-images having a location, said location and said compression scheme for each of said sub-images chosen based on said information in said data structure.

55. A program storage device readable by a machine, tangibly embodying a program of instructions executable by the machine to perform a method for reducing the size of a graphics image in a computer system, the method comprising:
adding a drawn-to region to an RGB region when a put image command is executed;
removing a drawn-to region from said RGB region when an opaque fill command is executed;
for any non-null RGB region, adding said non-null RGB region to a pixmap RGB region;
intersecting said pixmap RGB region with a clip region, resulting in a clipped RGB region; and
compressing said clipped RGB region using a compression scheme, said compression scheme optimized for use with RGB regions.
